(19) United States
(12) Patent Application Publication
(10) Pub. No.: US 2023/0105993 A1
(43) Pub. Date: Apr. 6, 2023

(54) RAPID POLYMERIZED CATECHOL BASED SURFACTANT ASSISTED INFILTRATION OF SOLID OXIDE ELECTROCHEMICAL CELL INFILTRATION USING SPRAYING METHOD

(71) Applicants: WEST VIRGINIA UNIVERSITY BOARD, Morgantown, WV (US); UNITED STATES DEPARTMENT OF ENERGY, Washington, DC (US)

(72) Inventors: Ozcan OZMEN, Hillsboro, OR (US); Shiwoo LEE, Arlington Heights, IL (US); Edward SABOLSKY, Morgantown, WV (US)

(21) Appl. No.: 17/759,822

(22) PCT Filed: Jan. 28, 2021
(86) PCT No.: PCT/US21/15481

§ 371 Date: Jul. 29, 2022

Related U.S. Application Data
(60) Provisional application No. 62/968,492, filed on Jan. 31, 2020.

(51) Int. Cl. H01M 4/90; H01M 8/1246; H01M 4/86; H01M 4/88

(52) U.S. Cl. CPC H01M 4/9008; H01M 8/1246; H01M 4/8605; H01M 4/886; H01M 4/8885; H01M 2008/1293

(57) ABSTRACT

The present invention provides a process for incorporating at least one nano-catalyst on the surface of and within a plurality of pores of an electrode. The process includes spraying or dripping a catechol based surfactant onto the surface of and within one or more pores of a solid oxide electrochemical cell having an anode electrode and a cathode electrode; spraying or dripping a nano-catalyst solution onto the surface of and within one or more pores of the solid oxide electrochemical cell that has been pretreated with the catechol based surfactant for forming a modified solid oxide electrochemical cell; and firing the modified solid oxide electrochemical cell above a calcination temperature of the nano-catalyst solution for forming a nano-catalyst on the surface and within at least one or more pores of the solid oxide electrochemical cell.

### CROSS-REFERENCE TO RELATED APPLICATION

This utility non-provisional patent application claims the benefit of and priority to U.S. Provisional Patent Application Ser. No. 62/968,492, filed Jan. 31, 2020. The entire contents of U.S. Provisional Patent Application Ser. No. 62/968,492 is incorporated by reference into this utility non-provisional patent application as if fully rewritten herein.

### STATEMENT REGARDING FEDERALLY SPONSORED RESEARCH OR DEVELOPMENT

This invention was made with government support under Grant No. DE-FE0004000 awarded by the Department of Energy. The government has certain rights in the invention.

### BACKGROUND OF THE INVENTION

### 1. Field of the Invention

The present invention relates to an electrode infiltration method for solid oxide fuel and electrolysis cells. One embodiment of this invention provides a homogeneous metal or metal oxide nano-catalyst deposition within a commercial porous electrode architecture by an initial treatment with a rapid-polymerizable catechol based bio-surfactant application (without altering the existing microstructure). The present invention is a process that is facile and effective that needs only one singular firing step, unlike most of the other background art infiltration protocols. In the present process, the use of surfactant application promotes smaller nano-catalyst particle size with the high surface area which enhances the electrochemical performance.

### 2. Description of the Background Art

Solid Oxide Electrochemical Cells (SOECs) are one promising system for power generation and hydrogen storage applications that operate up to 500 to 1000° C. Basically, SOEC's cell performance is limited by three factors: 1) transportation of charge related to ohmic losses, 2) catalytic deactivation of the electrodes, 3) gas starvation/transportation of ions related to mass transport losses. The third, also the least dominant factor, can be minimized by control of the microstructure within the SOECs electrodes and through the modification of the stack design to provide a good and homogeneous delivery of the oxidant/fuel to the electrodes. The first and the second factors can be minimized by engineering the microstructure and composition of the electrodes. Typically, catalytic activity and conductivity within the electrode structure is proportionally related to the length of the triple phase boundary (TPB) and/or double phase boundary (DPB). The main electrochemical reactions (both oxidation and reduction reactions) occur at the triple phase boundary (termed as TPB or 3PB), which is the point of contact of the electronic conductor, oxygen ion conductor, and reactant. For electrodes containing mixed ionic-electronic conducting (MIEC) materials, the double-phase boundary (DPB, or 2PB) dominates at the point of contact to the MIEC and the reactant. Hence, extending the triple-phase boundary (TPB) and/or double phase boundary (DPB) promotes the interfacial electrochemical activity of the cells. This can be done by incorporating catalytically active nanomaterials within the electrodes. Unfortunately, the inclusion of nanomaterials within SOEC electrodes potentially causes unwanted structural instabilities since the conventional sintering temperature of electrode constituents are typically >1000° C. Regardless, researchers have incorporated both nano- and micron-sized particles into SOEC electrodes, where a conventional porous electrode microstructure (with micron-size grains) are used to support and maintain the stability of the electrode. The nanomaterials with the proper catalysis activity provides an enhancement to the oxidation reduction reaction (for the cathode) or the fuel oxidation reaction (for the anode). One prime method used by researchers to introduce the nano-catalyst is through a wet infiltration or impregnation process of a liquid-based solution or dispersion to deposit the nanomaterials with the porous electrodes. Existing infiltration methods are known to be very labor-intensive and time-consuming protocols. Repetitive infiltration and firing steps are needed to achieve desired catalyst loading and performance enhancement. Moreover, the electrode microstructure is usually re-engineered to achieve more interconnected porosity for a better infiltration efficiency.

### SUMMARY OF THE INVENTION

In one embodiment of this invention, a process is provided, for incorporating at least one nano-catalyst on the surface of and within a plurality of pores of an electrode comprising: spraying a catechol based bio-surfactant onto a surface of and within one or more pores of a solid oxide electrochemical cell having an anode electrode and a cathode electrode; spraying a nano-catalyst solution onto said surface of and within said one or more pores of said solid oxide electrochemical cell that was pretreated with said catechol based bio-surfactant for forming a modified solid oxide electrochemical cell; and firing said modified solid oxide electrochemical cell above a calcination temperature of said nano-catalyst solution for forming a nano-catalyst on said surface and within at least one or more pores of said solid oxide electrochemical cell.

In another embodiment of this invention, the process, as described herein, includes wherein said catechol based bio-surfactant is one selected from the group consisting of dopamine hydrochloride (3,4-dihydroxyphenethylammonium chloride 3-hydroxytyramine hydrochloride, epinephrine hydrochloride, 3,4-dihydroxyhydrocinnamic acid, 3-(3,4-dihydroxyphenyl) propionic acid, hydrocaffeic acid, caffeic acid (3,4-dihydroxybenzeneacrylic acid), 3,4-dihydroxycinnamic acid, 3-(3,4-dihydroxyphenyl)-2-propenoic acid, gallic acid (3,4,5-Trihydroxybenzoic acid), 4,5-Dihydroxy-1,3-benzenedisulfonic acid disodium salt, pyrocatechol-3,5-disulfonic acid disodium salt, adrenalone hydrochloride (3′,4′-dihydroxy-2-(methylamino)acetophenone hydrochloride), and nor-epinephrine.

In another embodiment of this invention, the process as described herein, includes after spraying said catechol based bio-surfactant onto said surface of and within one or more pores of said solid oxide electrochemical cell, and before spraying said nano-catalyst solution, spraying said catechol based bio-surfactant treated solid oxide electrochemical cell with an oxidant agent solution to cause polymerization of said catechol based bio-surfactant within a range of time from about one second to less than about one hour.

In another embodiment of this invention, the process, as described herein includes wherein said oxidant agent is one selected from the group consisting of an iodate (IO₃⁻) group, a periodate (IO₄⁻) group, a bromite (BrO₃⁻) group, and a perbromate (BrO₄⁻) group. Preferably, the process, as described herein, includes wherein said oxidant agent is one selected from the group consisting of tetrabutylammonium (meta) periodate ((CH₃CH₂CH₂CH₂)₄N(IO₄), sodium periodate (sodium (meta)periodate, NaIO₄, a periodic acid (H₅IO₆), and a perbromic acid (HBrO₄). Or preferably, the process, as described herein, includes wherein the oxidant agent is an ammonium periodate solution.

In another embodiment of this invention, the process, as described herein, includes mixing said catechol based bio-surfactant with an oxidant agent solution to form a polymerizing mixture of said catechol based bio-surfactant and said oxidant solution, and then immediately spraying said polymerizing mixture onto said surface of and within one or more pores of said solid oxide electrochemical cell.

In a preferred embodiment of this process, as described herein, includes wherein said catechol based bio-surfactant is a nor-epinephrine solution and said oxidant agent is an ammonium periodate solution.

Another embodiment of the process of this invention, as described herein, includes wherein said spraying of said catechol based bio-surfactant is in the form of an atomized aerosol.

In another embodiment of this invention, a process is provided for incorporating at least one nano-catalyst on the surface of and within a plurality of pores of an electrode comprising: dripping by point deposition a catechol based bio-surfactant onto a surface of and within one or more pores of a solid oxide electrochemical cell having an anode electrode and a cathode electrode; dripping by point deposition a nano-catalyst solution onto said surface of and within said one or more pores of said solid oxide electrochemical cell that has been pretreated with said catechol based bio-surfactant for forming a modified solid oxide electrochemical cell; and firing said modified solid oxide electrochemical cell above a calcination temperature of said nano-catalyst solution for forming a nano-catalyst on said surface and within at least one or more pores of said solid oxide electrochemical cell. In a preferred embodiment of this process, this process includes after dripping said catechol based bio-surfactant onto said surface of and within one or more pores of said solid oxide electrochemical cell, and before dripping said nano-catalyst solution, treating said catechol based bio-surfactant treated solid oxide electrochemical cell with an oxidant agent solution to cause polymerization of said catechol based bio-surfactant within a range of time from about one second to less than about one hour. More preferably, this process includes mixing said catechol based bio-surfactant with an oxidant agent solution to form a polymerizing mixture of said catechol based bio-surfactant and said oxidant solution, and then immediately dripping by point deposition said polymerizing mixture onto a surface of and within one or more pores of said solid oxide electrochemical cell.

### BRIEF DESCRIPTION OF THE DRAWINGS

FIG. 1 shows a schematic of a mixture of catechol-based surfactant solution and oxidant solution spraying on to the fuel cell electrode to form rapid polymerization protocol in one step.

FIG. 2(a) shows a schematic of catechol-based surfactant solution spraying on to the fuel cell electrode to form rapid polymerization protocol in two successive steps.

FIG. 2(b) shows a schematic of oxidant solution spraying on to the fuel cell electrode to form rapid polymerization protocol in two successive steps.

FIG. 3 shows background art infiltration methods applied for anode electrode in selected published studies between 2003 through 2016.

FIG. 4(a) shows a SEM image of PSCo nano-catalyst infiltrated LSCF cathode microstructure with no-treatment.

FIG. 4(b) shows a SEM image of PSCo nano-catalyst infiltrated LSCF cathode microstructure with r-PNE treatment.

FIG. 5 shows polarization resistance bar charts of baseline, PSCo infiltrated, and r-PNE assisted PSCo infiltrated cell.

FIG. 6(a) shows a SEM image of PBC nano-catalyst layer sprayed on no-PNE treated YSZ single crystal surface.

FIG. 6(b) shows a SEM image of PBC nano-catalyst layer sprayed on no-PNE treated YSZ single crystal surface.

FIG. 6 (c) shows a SEM image of PBC nano-catalyst layer sprayed on r-PNE treated YSZ single crystal surface.

FIG. 6 (d) shows a SEM image of PBC nano-catalyst layer sprayed on r-PNE treated YSZ single crystal surface.

FIG. 7(a) shows a SEM image of PBC nano-catalyst layer sprayed on no-PNE treated LSM pellet surface.

FIG. 7(b) shows a SEM image of PBC nano-catalyst layer sprayed on no-PNE treated LSM pellet surface.

FIG. 7(c) shows a SEM image of PBC nano-catalyst layer sprayed on r-PNE treated LSM pellet surface.

FIG. 7(d) shows a SEM image of PBC nano-catalyst layer sprayed on r-PNE treated LSM pellet surface.

FIG. 8 shows molecular structure of example catechol based surfactant materials.

### DETAILED DESCRIPTION OF THE INVENTION

The first use of catechol surfactant treatment in the SOEC field was developed by E. M. Sabolsky and O. Ozmen et al. (Pub. No.: US 2016/0172683 A1), now U.S. Pat. No. 10,087,531. U.S. Pat. No. 10,087,531 discloses use of catechol surfactants polymerized by the conventional route where the monomers are crosslinked, in other words, polymerized naturally in 12-24 hours. The process set forth in U.S. Pat. No. 10,087,531, includes a dip-coating method where the whole cell is submerged into a container filled with pre-polymerized catechol solution. The dipping method is chosen to facilitate the electrode modification; however, fuel cell dimensions and batch multi-cell coatings can be limited by the coating container dimensions. These aspects limit the practicality and continuity of scaled up infiltration line.

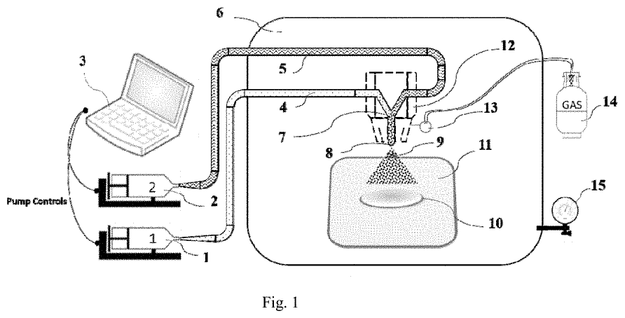

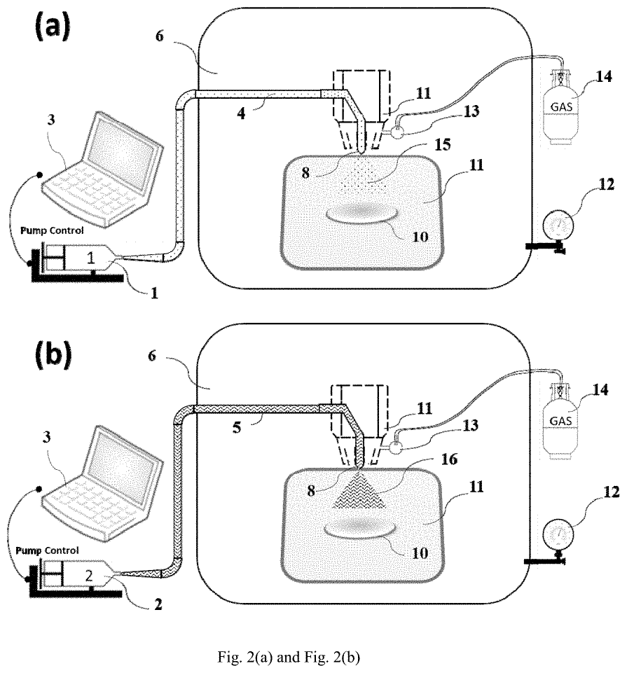

The present invention differs from the teachings of U.S. Pat. No. 10,087,531. The present invention focusses on being a swift and more effective process to decorate nanocatalyst particles homogenously in a porous electrode with enhanced particle surface area and coverage, hence the catalytic activity. In one embodiment of the present invention, the process includes a spray impregnation for the rapid polymerization of a catechol-based bio-surfactant into the fuel cell electrode microstructure, as the initial step of the process. The second step of this process of this invention includes the spray impregnation of the nano-catalyst precursor into the same electrode microstructure, where the surfactant controls the wetting and deposition of the nano-catalyst. The method of this invention permits the modification of both electrodes (anode and cathode) by the rapid-polymerized bio-surfactant spraying treatment. The rapid polymerization process is dependent upon spraying both the surfactant precursor solution and the oxidant solution (where the medium may be water, alcohol, or organic liquid) that can be either mixed in the spraying tubing close to the nozzle instantaneously (solutions are being kept in separate containers) and sprayed in a single spraying route (FIG. 1) or the solutions can be sprayed separately by successively steps (FIG. 2). As used herein, the term “rapid polymerization” is defined as polymerization that occurs within a range of time from about one second to less than about one hour.

In one embodiment of this invention, a process is provided, for incorporating at least one nano-catalyst on the surface of and within a plurality of pores of an electrode comprising: spraying a catechol based bio-surfactant onto a surface of and within one or more pores of a solid oxide electrochemical cell having an anode electrode and a cathode electrode; spraying a nano-catalyst solution onto said surface of and within said one or more pores of said solid oxide electrochemical cell that has been pretreated with said catechol based bio-surfactant for forming a modified solid oxide electrochemical cell; and firing said modified solid oxide electrochemical cell above a calcination temperature of said nano-catalyst solution for forming a nano-catalyst on said surface and within at least one or more pores of said solid oxide electrochemical cell.

In another embodiment of this invention, the process, as described herein, includes wherein said catechol based bio-surfactant is one selected from the group consisting of dopamine hydrochloride (3,4-dihydroxyphenethylammonium chloride 3-hydroxytyramine hydrochloride, epinephrine hydrochloride, 3,4-dihydroxyhydrocinnamic acid, 3-(3,4-dihydroxyphenyl)propionic acid, hydrocaffeic acid, caffeic acid (3,4-dihydroxybenzeneacrylic acid), 3,4-dihydroxycinnamic acid, 3-(3,4-dihydroxyphenyl)-2-propenoic acid, gallic acid (3,4,5-Trihydroxybenzoic acid), 4,5-Dihydroxy-1,3-benzenedisulfonic acid di sodium salt, pyrocatechol-3,5-disulfonic acid disodium salt, adrenalone hydrochloride (3′,4′-dihydroxy-2-(methylamino)acetophenone hydrochloride), and nor-epinephrine.

In another embodiment of this invention, the process as described herein, includes including after spraying said catechol based bio-surfactant onto said surface of and within one or more pores of said solid oxide electrochemical cell, and before spraying said nano-catalyst solution, spraying said catechol based bio-surfactant treated solid oxide electrochemical cell with an oxidant agent solution to cause polymerization of said catechol based bio-surfactant within a range of time from about one second to less than about one hour.

In another embodiment of this invention, the process, as described herein includes wherein said oxidant agent is one selected from the group consisting of an iodate (IO₃⁻) group, a periodate (IO₄⁻) group, a bromite (BrO₃⁻) group, and a perbromate (BrO₄⁻) group. Preferably, the process, as described herein, includes wherein said oxidant agent is one selected from the group consisting of tetrabutylammonium (meta) periodate ((CH₃CH₂CH₂CH₂)₄N(IO₄), sodium periodate (sodium (meta)periodate, NaIO₄, a periodic acid (H₅IO₆), and a perbromic acid (HBrO₄). Ore preferably, the process, as described herein, includes wherein the oxidant agent is an ammonium periodate solution.

In another embodiment of this invention, the process, as described herein, includes mixing said catechol based bio-surfactant with an oxidant agent solution to form a polymerizing mixture of said catechol based bio-surfactant and said oxidant solution, and then immediately spraying said polymerizing mixture onto said surface of and within one or more pores of said solid oxide electrochemical cell.

In a preferred embodiment of this process, as described herein, includes wherein said catechol based bio-surfactant is a nor-epinephrine solution and said oxidant agent is an ammonium periodate solution.

Another embodiment of the process of this invention, as described herein, includes wherein said spraying of said catechol based bio-surfactant is in the form of an atomized aerosol.

In another embodiment of this invention, a process is provided for incorporating at least one nano-catalyst on the surface of and within a plurality of pores of an electrode comprising: dripping by point deposition a catechol based bio-surfactant onto a surface of and within one or more pores of a solid oxide electrochemical cell having an anode electrode and a cathode electrode; dripping by point deposition a nano-catalyst solution onto said surface of and within said one or more pores of said solid oxide electrochemical cell that has been pretreated with said catechol based bio-surfactant for forming a modified solid oxide electrochemical cell; and firing said modified solid oxide electrochemical cell above a calcination temperature of said nano-catalyst solution for forming a nano-catalyst on said surface and within at least one or more pores of said solid oxide electrochemical cell. In a preferred embodiment of this process, this process includes after dripping said catechol based bio-surfactant onto said surface of and within one or more pores of said solid oxide electrochemical cell, and before dripping said nano-catalyst solution, treating said catechol based bio-surfactant treated solid oxide electrochemical cell with an oxidant agent solution to cause polymerization of said catechol based bio-surfactant within a range of time from about one second to less than about one hour. More preferably, this process includes mixing said catechol based bio-surfactant with an oxidant agent solution to form a polymerizing mixture of said catechol based bio-surfactant and said oxidant solution, and then immediately dripping by point deposition said polymerizing mixture onto a surface of and within one or more pores of said solid oxide electrochemical cell.

The main advantage of the process of the present invention is that as the utilization of spraying method lowers the processing time and labor needed to complete the deposition, since the process requires two or three (depending on the polymerization technique of the catechol-based bio-surfactant) spraying steps. Rapid polymerization route significantly lowers the time needed for the natural polymerization of the catechol surfactant. Natural polymerization of a catechol-based surfactant at pH 8.5 takes approximately 12-24 hours. The polymerization can be visually traced by the color shift from a clear fresh solution to a polymerized solution, such as black color for poly-dopamine, brown for poly-norepinephrine, yellow/orange for poly-3,4-dihydroxyhydrocinnamic acid, yellow-green for poly-gallic acid and red for poly-caffeic acid etc. To shorten the polymerization time, a catechol-based surfactant solution can be mixed with an oxidant agent solution. This is why the method as we have termed “rapid-polymerization” consists of spraying of catechol-based bio-template surfactant solution and the oxidation agent solution to the electrode surface simultaneously (FIG. 1) or successively (FIG. 2).

FIG. 1 is a schematic depicting the rapid polymerization treatment method of this invention in one step. More particularly, FIG. 1 shows a schematic of a mixture of catechol-based surfactant solution and oxidant solution spraying on to the fuel cell electrode to form rapid polymerization protocol in one step. Dimensions of certain parts shown in the drawing may have been modified and/or exaggerated (i.e., not drawn to scale) for the purposes of clarity or illustration. Disclosed in FIG. 1 is a process of introducing catechol-based surfactant into the porous SOEC electrode. First, the catechol-based surfactant and the oxidizing agent solutions are placed in separate containers with syringe pumps number 1 (1) and number 2 (2), respectively. Surfactant:oxidant ratio can be tuned with a computer-controlled syringe pump system (3). Solutions with the desired ratio controlled by the computer (3) convey through the tubing (4) and (5) inside the isolated chamber (6). Conveyed solutions mix close to the tip (8) of the spraying/dispensing apparatus (7) where the rapid polymerization step is induced through the mixing to nozzle tip path (8). Mix solution instantaneously sprayed/dispensed (9) onto the anode or cathode electrode (10) on a platen (11) via a spraying unit (12) in the chamber. Platen can be heated to control drying conditions of sprayed liquid. The spraying unit (12) contains a low-pressure gas inlet (13) which is connected to a gas cylinder (14) outside of the chamber. Spraying catechol surfactant solutions (8) with low pressure jet of gas produces soft and focused beam of spray drops. During the bio-surfactant templating, the chamber may be vacuumed or pressurized (15) to promote penetrability of the sprayed solution (9). Alternatively, the process can be applied with two successive steps as shown in FIGS. 2(a) and 2(b).

FIG. 2(a) shows a schematic of catechol-based surfactant solution spraying on to the fuel cell electrode to form rapid polymerization protocol, and FIG. 2(b) shows a schematic of oxidant solution spraying on to the fuel cell electrode to form rapid polymerization protocol in two successive steps. FIG. 2(a) and FIG. 2(b) shows, firstly, the catechol-based surfactant is placed in a container with a syringe pump number 1 (1). Surfactant dispensing volume can be tuned by a computer-controlled syringe pump system (3). Solution conveys through the tubing (4) inside the isolated chamber (6). Conveyed solution sprayed/dispensed (15) at the nozzle tip (8) of a spraying unit (12) onto the fuel cell electrode (10) on a platen (11) via a spraying unit (12) in the chamber. Secondly, oxidant solution is placed in a container with a syringe pump number 2 (2). Surfactant dispensing volume can be tuned by a computer-controlled syringe pump system (3). Solution conveys through the tubing (5) inside the isolated chamber (6). Conveyed solution is sprayed (15) at the nozzle tip (8) of a spraying unit (11) onto the anode or cathode electrode (10) on a platen (11) via a spraying unit (12) in the chamber. Platen can be heated to control drying conditions of sprayed liquids. The spraying unit (12) contains a low-pressure gas inlet (13) which is connected to a gas cylinder (14) outside of the chamber. Spraying catechol-based surfactant solution and oxidant solution (8) with low pressure jet of gas produces soft and focused beam of spray drops. For both steps, the chamber may be vacuumed or pressurized (12) to promote penetrability of the sprayed catechol-based surfactant (15) and oxidant solution (16). The utilization of the method induces a shorter bio-template polymerization time. Moreover, the rapid-polymerized mixture can easily be infiltrated into the electrode structure in an atomized aerosol form. The protocols (the single-step or two-step rapid polymerization, set forth herein) can also be applied by pipetting on the electrode surface. Secondly, the whole process needs only one firing step where previously demonstrated processes described in the literature require greater than two steps (deposition and drying) with multi-firing steps in order to achieve desired solid loading. Initially, the method includes one or two step(s) of bio-template surfactant material spraying; then the electrochemical cell may be exposed to the inorganic salt solution spray.

The electrochemical cell with the porous electrodes can be sprayed with a rapid-polymerized catechol solution for the desired spraying cycle to control the deposition and adhesion of the poly-catechol on the electrode microstructure. The thickness of the surface modifying poly-catechol agent depends upon the concentration of the monomer solution, pH, spraying cycle and the surfactant/oxidant ratio. The electrochemical cell electrode is then sprayed with a metal salt solution (containing the inorganic salt that will transform into the nanocatalyst composition) for a given specific spraying cycle. The spraying cycle dictates the thickness of the deposited polycrystalline film or islands of the nano-catalyst material within the porous electrode microstructure. After drying, the electrochemical cell is thermally processed to oxidize and transform to any desired solid-state reaction of the deposited material. The key is to set the thermal process at a temperature of <900° C. (i.e. less than about 900 degrees centigrade) to control the particle size of the nano-catalyst deposits (to restrict sintering and grain growth processes).

The initial demonstrations of the technology utilized a spraying method to polymerize the bio-template and infiltrate inorganic salt solution. A point deposition process (such as the use of a pipet or syringe) may be used to deposit and polymerize the poly-catechol and deposit the metal salt solutions at a specific location or across the whole electrode surface. This process is usually termed as a “dripping method”. In addition, the porous structure may be exposed to a negative or positive pressure to remove gas within the porous structure and to drive the liquid into the microstructure, respectively.

As described above, the advantages of using this enhanced deposition morphology method was to enhance the wetting of the porous electrode structure, enhance the homogeneity of the impregnated catalyst, and smaller the particle size of the fired nano-catalysts. Initiation of local chelation mechanism is between —OH groups in the polymerized molecule and free metal ions assists in the pinning (deposition and bonding), and hence, results in the control of ripening of the precipitates (leading to a smaller particle size of the nano-catalysts). In literature, the spraying of “bio-adhesives” have been utilized only on two-dimensional substrates, but never three-dimensional networks with multi-component chemistry, porous networks (such is typical for solid-state electrochemical cells). In order to deposit the bio-templates in such three-dimensional network, the presented spraying deposition method with rapid-polymerized biosurfactant technology was developed. Furthermore, the rapid polymerization process may also be utilized by the conventional successive dripping method of the bio-surfactant precursor and oxidant solutions.

Parameters such as bio-adhesive solid loading content, oxidant content, dispersant mixture (water, alcohol or other organic solvents), pH of the bio-adhesive dispersant mixture, spraying cycle and surfactant/oxidant molar ratio could be modified to tune the aggregate size, final thickness and decoration morphology of the rapid-polymerized bio-template. Different nano-catalyst cation sources could also be used as the precursor. Moreover, the precursor composition, solution modifier content and/or dispersant mixture (water, alcohol or other organic solvents) ratios could be modified in order to lower or raise the wetting characteristics of the precursor. Initial precursor molarity, the presence of modifiers, and spraying cycle number can be modified in order to engineer various catalyst morphologies (interconnected or discrete nano-infiltrant particles) or loading. Pressure and vacuum assistance could be applied to enhance the deposition rate of nano-catalyst. Calcination temperature could be modified to control the final particle size of impregnated nano-catalysts. Finally, the chemistry and the stoichiometry of the catalysis can be modified for the utilization of different types of fuel candidates or depending on the target electrode (anode and/or cathode). Through the presented technology, the nanocatalysts can be multiple component metals (such as mono-, bi-, and tri-component composites or alloys) or oxide nano-particles.

The technical description and constraints of the methods (processes) of this invention are:
The porosity of the candidate electrode for infiltration should consist of a percolated open structure (can be as low as 25% porosity level).
When the spraying method is preferred, the whole cell must be placed under the nozzle and the candidate electrode that is selected for infiltration must be facing towards the nozzle if the candidate is templated by a spraying method. The electrode can be sprayed within a single step of mixed biosurfactant solution and oxidant agent solution or within two short sequential steps of spraying of each solution separately.
When the dripping method is preferred, the bio-template and oxidant solutions must be dripped by a pipette to cover the active electrode boundary completely which is typically the smallest electrode surface area, if the candidate electrode is templated by the dripping method.
Depending on the percolation and the percentage of the pore ratio, the final surfactant aggregate size must be lower than 10-100 nm. Final aggregate size can be tuned with the solid concentration (varying 0.25 to 2 mg/ml), water/organic medium ratio (varying 100% water to 25% water/75% organic medium such as ethanol by volume) of both biosurfactant solution and oxidant solution, pH of the biosurfactant solution, and bio-surfactant/oxidant mixing ratio (1:4 to 4:1) at the tip of the spraying nozzle.
A buffering agent, such as TRIS, tris(hydroxymethyl)aminomethane), should be used to fix the pH at a desired point of the surfactant solution before rapid-polymerization by an oxidant agent.
After rapid polymerization, the aggregate size of the poly-catechol species must not be equal or higher than the average pore size (such as in most commercial solid-oxide fuel cells (SOFCs), >100 nm). Above this range, few polymerized catechol-based bio-molecule particles can clog the open pores, preventing the effective infiltration for both bio-templating and nano-catalyst solution impregnation steps.
The oxidant agent should be a weak oxidizer, such as those with a halogen group (such for example but not limited to iodates, periodates, bromates or perbromates) to avoid any uncontrolled oxidation and rapid heat formation.
The oxidant agents listed above should not contain known electrode poisoning species such as a sulfate group.
Rapid polymerized bio-templating process follows by the nano-catalyst infiltration to the electrode. The catalyst infiltration process can either be carried by the same spraying equipment/method or by the conventional dripping method, or other methods that are shown in FIG. 1, and FIG. 2(a) and FIG. 2(b).
The spraying unit contains a low-pressure gas inlet which is connected to a gas cylinder outside of the chamber as, but not limited to, air, nitrogen, argon, helium etc. Spraying catechol surfactant solutions with low pressure jet of gas produces soft and focused beam of spray drops.
Following by the bio-templating and/or catalyst precursor spraying, the system can be exposed to a vacuum to evacuate air imprisoned in the 3-D porous structure; otherwise, this could promote infiltration by eliminating air entrapped gas acting as a barrier layer for the infiltration. Depending on the thickness and the surface area of the cell, the amount needed for the vacuuming may change, but it should be at least about 5 minutes under about 30 mm Hg.
Nano-catalyst infiltration is followed by the final drying step. The cell can either be dried at room temperature or at elevated temperatures (i.e. at temperatures above the range of 20 to 25 degrees centigrade, with an average of 23 degrees centigrade) instantly. The platen (11) can be heated to control drying conditions of sprayed liquid. However, the drying temperature must not exceed the ignition temperature of the solvent in the presence of the catalyst. For example, 150-180° C. for cerium-based catalysis and ethanol.
The calcination temperature of the infiltrated electrode (or cell) must be higher than the decomposition temperature of the catalyst source.

Improving the electrode performance, and hence the overall power density (Watt per centimeter square, W/cm²), is one of the main motivations in SOFC and SOEC. Infiltration/impregnation of high surface area and catalytic nano-particles is one strategy to promote the catalytic activity and redox reaction rates. Enhancing the double and/or triple phase boundary (DPB, TPB) length by the catalytic nanoparticle reduces the polarization resistance.

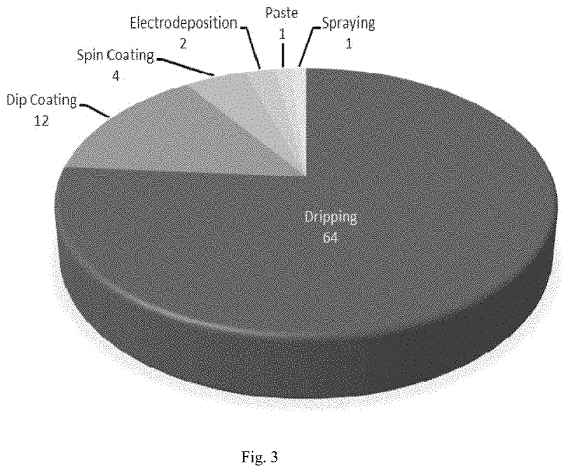

FIG. 3 shows various infiltration/impregnation methods shown in the literature from 2003 to 2016. It can be observed from FIG. 3 that the dripping method is the predominant method used in infiltration studies which can be performed by dripping metal salt or ceramic suspension on top of the electrode with a pipette. The concentration of solution/suspensions is usually kept very low to prevent agglomeration during drying and/or firing step. Hence, most impregnation (infiltration) protocols require multiple steps to achieve an adequate amount of nano-catalyst deposition within the electrochemical cells. Due to the suspension stabilization and inevitable clogging issues of porous network issues, nano-particle infiltration is a less preferred path. Instead, infiltration of metal salt solutions in water, alcohol or any organic solvent medium is practical and convenient precursor selection. Mostly nitrate and/or chloride salt solutions are being used at a concentration of 0.05 M to 5 M. After each infiltration step, the electrode (hence the whole cell) needs to be fired above the calcination temperature of the precursor solution to form nano-catalyst inside the structure. Due to the fast drying conditions of a small infiltrant precursor, the solution liquid segregates to the drying surface, forcing the dissolved cation to the surface site, and hence, most of the nano-catalyst is localized near the surface region after firing. This makes a blocking layer to the dissolved liquid in the next infiltration repetition. Hence, the deposition amount may be increased in each step, but most of the nano-catalyst formation end up being localized away from the active TPB area, where it is mainly at the deepest part of the electrode, near the electrolyte interface. For example, one study in literature focussed on the impregnation of samarium doped ceria (SDC) on NiO/SDC anode. The optimum catalyst loading was reached after the 7th infiltration cycles (20 mg/cm²). However, the performance of the infiltrated cell (25 mg/cm²) in the 9th cycle showed lower performance than the infiltrated cell (15 mg/cm²) in 5th cycle. Showing lower performance implied that the thicker SDC coating on the nickel particles within the anode block the gas diffusion to the TPB region. A similar profile can be seen in a study on impregnating SDC, Sm₂O₃, CeO₂ and Al₂O₃ to Ni-based anodes (Liu et al., J. Solid State Electrochem., 2012).

Although there are a few efforts on single-step infiltration studies by dip-coating or vacuum assisted dripping method, each approach has some drawbacks and limitations. A universal and tunable infiltration protocol that provides a controlled infiltration with discrete and desired amount of nano-catalyst decoration giving maximum TPB enhancement is currently an emerging research area in SOFC/SOEC industry and academic field. These tunable parameters such as, but not limited to, solution concentration, solvent type, viscosity, surfactant additives etc. can promote penetrability of the precursor through the porous network by lowering the surface tension and wettability. For example, a study by Godinez et al., observed that different types of surfactants such as Triton X-100, CMC, SDBS can influence the mobility of nanoparticles in a porous network (Godinez et al., Water Res, 2011). Moreover, some surfactants such as Triton X-100 and X-45 (Sholklapper et al., NanoLett., 2007), glycine (Jiang et al., Int. J. Hydrogen Ener., 2010), ethylene glycol (Buyukaksoy et al., ECS Trans. 2012), urea (Li et al., Electrochim. Acta., 2011) and citric acid (Nicholas et al., J. Electrochem. Soc., 2010), have been used as a chelating agent and/or as a modifier to promote phase and microstructure stability etc.

The aforementioned candidates are classified as solution modifiers. In addition, another strategy can be driven through modifying the substrate. By following this strategy, the liquid-solid interaction can be greatly promoted without any solvent and final chemistry dependence of catalyst precursor solutions. One modifier example is catechol-based surfactants. The use of the dopamine molecule was one of the first catechol-based surfactant introduced as a substrate modifier (Lee et al, Science, 2007). Poly-dopamine which is mimicked by mussel foot protein (MFP) and its derivatives can provide a material-independent and multifunctional surface nano-coatings. Only by buffering the surfactant solution to a pH of 8.5, as to mimic marine conditions for mussels, immersed substrates can be coated spontaneously with a thin poly-dopamine film within hours (Ball, J. Colloid. Interf. Sci., 2012). The catechol-based biomolecules are the key component of the technology, since this chemistry was found to adsorb and modify the chemistry of any surface (organic, metal, ceramic, and semiconductor). The chemical properties of this surface modifier also permit the controlled deposition (templating) of metal and metal oxide films over the bio-molecule and enhance the wetting of the electrode structure; as we call a bio-template layer. As a general description of the surfactant technology, the process includes the initial dissolution of catechol-based molecules, such as dopamine and norepinephrine, into an aqueous solution buffered to a constant pH. Dopamine and norepinephrine are biological chemicals found in animals and humans. Similar catechol molecules, such as 3,4-dihydroxyhydrocinnamic acid, gallic acid and caffeic acid, melanin, can also be used.

The application of catechol-based surfactants in solid oxide electrochemical cells was first introduced by the inventors. The research study included the use of poly-dopamine as a substrate modifier for SOFC electrodes; NiO/YSZ anode and LSM/YSZ cathode infiltration (Ozmen et al., Mater. Lett., 2016). PDA was in-situ polymerized overnight and the dip-coating method was chosen to infiltrate and modify both electrodes. A cerium salt solution was the selected catalyst precursor in the study. After a singular firing step, the nano-ceria deposited within the microstructure was nearly three times higher than the amount deposited using a protocol with no-PDA surfactant. In addition, discrete nano-ceria particles were achieved on the pore walls, even at locations deep within the active region of the electrodes owing to local chelation of cerium cations by PDA templating. With the presented technology, the homogenous bio-templating layer, covering evenly over the multi-phase 3D pore network, led to a homogenous nano-catalyst coating over the same pore surface, where the infiltrated nano-catalyst remained pinned during drying (without segregation to the surface). In the end, the bio-template was easily removed by thermolysis and the nano-catalyst was bonded to the pore wall through typical sintering processes.

Substrate coating studies in the literature are mostly performed by the typical dip-coating method where the substrate is submerged into a container filled with pre-polymerized catechol solution. In this method, the time needed for coating is the main constraint that limits the feasibility for scale-up and rapid use. The main reason of such long polymerization kinetics is basically due to the low dissolved oxygen concentration in the aqueous or semi-aqueous catechol solutions. There have been two common strategies to accelerate the polymerization/crosslinking rate of catechol solution. The first strategy is the addition of a transition-metal-ion such as Mn²⁺ (Barreto et. al., Spectrochim. Acta A., 1999), Fe³⁺ (Kienzl et al., Life Sci., 1999), Cu²⁺ (Hedlund et al., Biomacromolecules, 2009), Ni²⁺ and Zn²⁺ (Bernsmann et al., Langmuir, 2011) etc., into the solution as a complex-binding agent. Metal ions bond with the OH⁻ group of the two catechol molecules and can be crosslinked in DOPA-Mⁿ⁺-DOPA formation, where Mⁿ⁺ is the transition metal ion. The second approach is the addition of water oxidation catalyst (WOC) such as ammonium persulfate, sodium perchlorate (Wei et al., Polym. Chem., 2010) and sodium periodate (Mills et al., J. Mater. Chem. A, 2016) (Hong et al., Adv. Mater. Interfaces, 2016) to promote the oxygen amount which increased the polymerization rate of the surfactant monomers in the solutions.

The technology described herein introduces a rapid polymerized bio-template assisted infiltration protocol for infiltration/impregnation of the nano-catalyst within the electrode microstructure. Bio-templating method has been mostly utilized for 2D smooth surfaces such as glass, Si-rubber, PTFE etc. Only a few studies have been assessed on the coating of 3D architectures such as membranes or biomaterial scaffolds. The common structure of catechol coated 3D architecture is being a single solid chemical phase with the high porosity values up to 40% (Ryou et al, Adv. Mater., 2011) to 85% with a large pore size (300 μm) (Wu et al., J. Mater. Chem, 2011). Our technology investigated the benefit of post-fired nano-catalyst formation and decoration of rapid-polymerized bio-templated 3-D electrode network of Solid Oxide Electrochemical Cells.

### Preferred Embodiments of the Present Invention

In the present invention, an automated solution dispensing equipment which atomizes the solution with a built-in sonicator at the nozzle and a compressed air inlet set up is used. The setup allows for the breaking up of the solution into very small aerosols. Hence, the surface tension is lowered as the droplet size gets smaller,—smaller than a droplet dispensed by a pipette—(R. C. Tolman, J. Chem. Phys., 1947). Lowering the surface tension can greatly promote the penetration capability into the porous SOFC/SOEC electrode structure. Another advantage is that these small and discrete aerosols have faster drying kinetics due to their high surface area. Smaller droplet size can also minimize the preferential drying at the liquid/solid interface inside the electrode. Hence, inhomogeneous deposition of the nano-catalyst precursor (where there is a gradient identified from the surface to the electrolyte interface) can be avoided. The system is also controllable in terms of spraying cycle, spraying speed and dispensing volume per minute etc.

As in many two-dimensional material systems and applications, catechol bio-templating of three-dimensional SOFC electrodes also enhanced the wettability and nano-catalyst deposition yield by local-chelating functionality within the structure. However, despite the beneficial functionality and being a facile process, naturally polymerized catechol coatings involve lack of practicality in terms of the extended preparation and coating time required for polymerization and achieving proper template thickness. As mentioned above, natural polymerization of catechols takes 12-15 hours which limits the practicality of the protocol. Our technology includes rapid polymerization catechol solution and a WOC (water oxidation catalyst) solution. The reaction of WOC can be formalized as in Equation (1):

nOₓ+2H₂O [symbol] nRed+4H⁺+O₂ Equation (1)

where Oₓ is the oxidant, H₂O is water, Red is the reduced form of Oₓ, and n is the number of equivalents necessary to consume 4 e⁻ from water (Mills et al., J. Mater. Chem., 2016). Hence, the polymerization kinetics is basically driven by a higher dissolved oxygen concentration in the aqueous or semi-aqueous catechol solution. One important criterion is that the WOC solution should not contain any known electrode poisoning ions such as sulfate groups which may potentially affect the overall catalytic activity uptake after nano-catalyst precursor infiltration. Moreover, the usage of strong halogen-based oxidizers which have unstable and explosive character must be avoided. In that sense, oxidant agents such as for example, but not limited to, iodate (IO₃⁻), periodates (IO₄⁻), bromite (BrO₃⁻) and perbromate (BrO₄⁻) groups should be preferred.

The flexibility of the application is that the rapid polymerization step can be utilized by an on-demand liquid dispensing equipment where the solution(s) is delivered in aerosol form. Here, the catechol solution and the WOC solution can be mixed close to the dispensing nozzle, so the bio-template is sprayed in one single step. Alternatively, the catechol solution and WOC solution can be also sprayed in successive order, as is called the two-step bio-templating process, if the spraying unit does not allow solution premixing. Moreover, these two solutions can also be applied by the drip-coating method by pipetting onto the electrode by the same consecutive order in two steps or a single dripping action of the premixed solution.
Those persons skilled in the art will appreciate that the present invention provides five distinct advantages over other impregnation processes:
The rapid polymerization is not dependent upon the chemistry or wetting characteristics of the substrate or deposited material (nano-catalyst).
The adhesive effect of the rapid-polymerized bio-template surface modifier permits the pinning of the nano-catalyst after deposition and restricts migration during solvent drying.
The WOC assisted rapid-polymerization can greatly reduce the time needed for polymerization from 12-15 hours to seconds (instant polymerization).
Bio-template thickness and morphology can be tunable by catechol:surfactant ratio, and aforementioned other parameters, such as but not limited to pH, catechol solution and oxidant solid loading, catechol:oxidant ratio and spraying/dripping cycle etc.
An on-demand spraying unit may be used, where the aerosol formation can greatly reduce the droplet size which reduces the surface tension of the liquid and hence increases the wettability.

### Data and Results

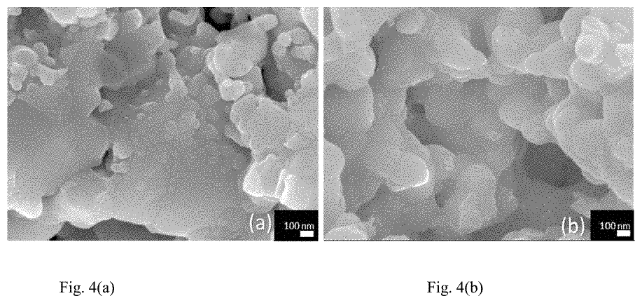

To present the flexibility of the present invention, our technology was applied with two different oxidant agent solution on to the three different SOEC electrode compositions as substrates. Our first approach was rapid polymerized catechol surfactant assisted Pr_{0.6}Sr_{0.4}Co_{3-δ} (PSCo) catalyst infiltration into the commercial La_{0.58} Sr_{0.4} Co_{0.2}F e_{0.8}O_{3-δ} o (LSCF) cathode. Primarily, NE solution, as a catechol surfactant, and ammonium periodate solution, as an oxidant agent, in separate containers were infiltrated with a spraying unit nozzle where two solutions were mixed close to the tip (8). The surfactant:oxidant molar mixing ratio was set to 2:1 to obtain rapid polymerized surfactant mixture (r-PNE). Secondly, the metal salts of PSCo composition were sprayed as the catalytic activity enhancer catalyst agent into the r-PNE treated and untreated commercial LSCF cathode electrodes. FIG. 4(a) and FIG. 4(b) show the cross-sectional scanning electron microscope (SEM) image of PSCo nano-catalyst infiltrated (FIG. 4b) r-PNE treated, and (FIG. 4a) no PNE treated cathode. The infiltrated PSCo inside the cathode electrode with no treatment was measured around 100 nm. It can be seen in FIG. 4(b) that the r-PNE modification of on the cathode electrode dramatically reduced the nano-catalyst particle size from 100 nm to sub-10 nm PSCo catalyst particles. Moreover, the decoration of PSCo particles had discrete, non-touching, morphology which inhibits the main driving force of possible particle coarsening mechanism(s). FIG. 4(a) shows a SEM image of PSCo nano-catalyst infiltrated LSCF cathode microstructure with no-treatment. FIG. 4(b) shows a SEM image of PSCo nano-catalyst infiltrated LSCF cathode microstructure with r-PNE treatment.

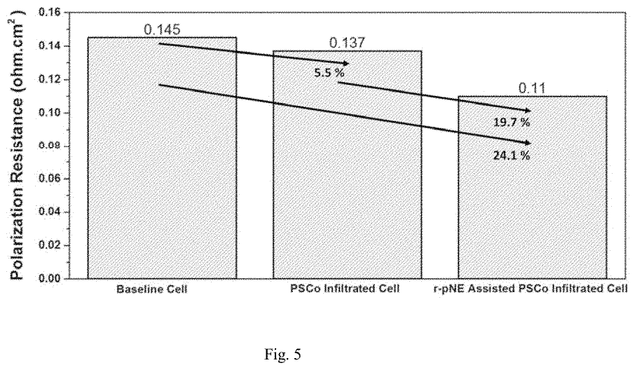

The infiltrated cells were tested to observe the effect of the smaller and discrete nanoparticles impregnated into the SOFCs. Commercial button cells were tested 750° C. under 0.25 A/cm² constant current load. FIG. 5 displays the comparison of the total polarization resistance, Rₚ, of those infiltrated cells versus the baseline cell as the infiltration process. FIG. 5 shows polarization resistance bar charts of baseline, PSCo infiltrated, and r-PNE assisted PSCo infiltrated cell. Here, the bar chart clearly revealed the benefit of the incorporation of the discrete PSCo nanoparticles inside the cathode electrode as the Rₚ of the r-PNE assisted PSCo infiltrated cell had 19.7% lower than non-PNE surfactant treated PSCo infiltrated cell. Overall, this cell showed 24.1% lower Rₚ than the baseline cell.

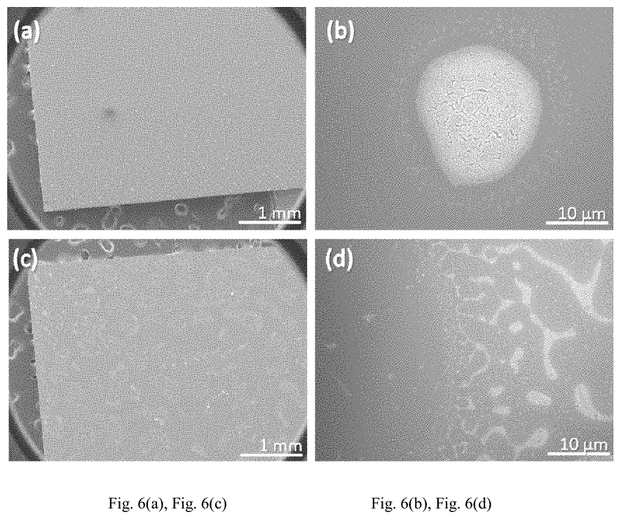

Our second approach included same protocol sprayed onto the planar YSZ and LSM substrates and with PrBaCo₂O_{5+d} (PBC) catalyst system. FIG. 6(a) shows a SEM image of PBC nano-catalyst layer sprayed on no-PNE treated YSZ single crystal surface. FIG. 6(b) shows a SEM image of PBC nano-catalyst layer sprayed on no-PNE treated YSZ single crystal surface. FIG. 6 (c) shows a SEM image of PBC nano-catalyst layer sprayed on r-PNE treated YSZ single crystal surface. FIG. 6 (d) shows a SEM image of PBC nano-catalyst layer sprayed on r-PNE treated YSZ single crystal surface.

FIG. 6(a) and FIG. 6(b) display the PBC coating on a planar YSZ substrate. PBC particles formed islands on the YSZ substrate which were ˜15 microns in size due to the surface tension between the YSZ surface and the catalyst precursor mist droplet. However, the r-PNE treated YSZ substrate was well coated with the PBC particles as seen FIG. 6(c) and FIG. 6(d). The results indicated that r-PNE treatment modified the YSZ surface effectively. As mentioned above and reported in the literature, catechol based bio-surfactant reduced the wetting angle of the liquid-solid interface. Hence, metal salt spray aerosol aggregation during the drying step was prevented.

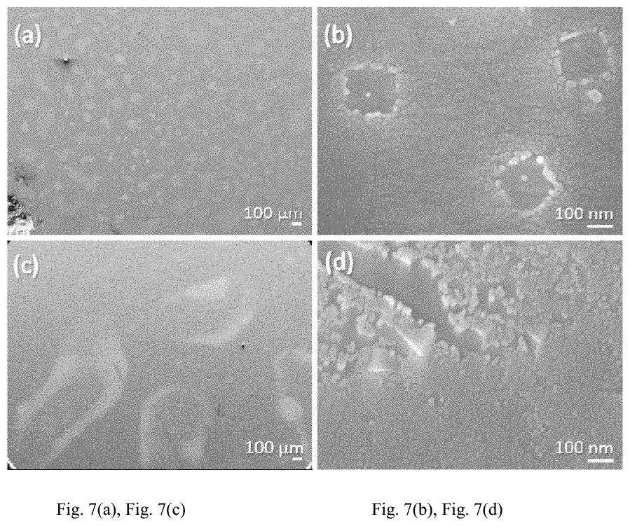

Furthermore, FIG. 7(a), FIG. 7(b), FIG. 7(c), and FIG. 7(d) show a PBC coating on a LSM substrate. More particularly, FIG. 7(a) shows a SEM image of PBC nano-catalyst layer (coating) sprayed on no-PNE treated LSM pellet surface. FIG. 7(b) shows a SEM image of PBC nano-catalyst layer sprayed on no-PNE treated LSM pellet surface. FIG. 7(c) shows a SEM image of PBC nano-catalyst layer sprayed on r-PNE treated LSM pellet surface. FIG. 7(d) shows a SEM image of PBC nano-catalyst layer sprayed on r-PNE treated LSM pellet surface. Similar to YSZ, scanning electron microscope images of LSM surface display PBS catalyst coating is more homogenous on to the r-PNE treated surface (FIG. 7(c)) than the non-treated surface (FIG. 7(a)). The nano-catalyst distribution and average size were found very close on coated LSM pellets (FIG. 7(b)) without and (FIG. 7(d)) with r-PNE treatment. Besides from the macro-scale coverage enhancement, the observation of having similar distribution and size was due to the crystal structure matching feature between PBC catalyst and LSM backbone. In conclusion, the results showed that catalyst deposition and coverage can be enhanced by PNE surfactant treatment could potentially normalize backbone materials independent of the crystal structure. Hence, surfactant treatment would prevent preferential catalyst deposition over likewise crystal structure.

The infiltration process of this invention can be applied to infiltrate nano-catalyst into the anode and cathode electrodes of Solid Oxide Fuel Cells (SOFCs). In that case, suitable metallic, metallic alloys and metal oxide nano-catalysts as oxidation/reduction enhancing catalyst, an internal reforming catalyst, grain growth inhibitors and contaminant-resistant or preventing materials can be infiltrated. This allows the flexibility of fuel use such as hydrogen, methane, and coal syngas; in addition, the long-term stability may be controlled with the selective nano-catalyst selection, as well, as an increase in electrochemical performance. The key is that the protocol may be applied to existing commercial SOFCs or SOECs without requiring current manufacturers to alter their current product's microstructure (and thus, major processing methods and materials). The process developed can be added to any existing products.

The present invention may be implemented for a variety of types of electrochemical cell applications, for example but not limited to, the following examples: 1) Specific nano-catalysts for utilization of various fuel types such as shale gas, natural gas, 2) Sizes/geometry SOFC and SOECs such as planar, tubular cells, 3) SOFC's types such as electrolyte, cathode or metal supported SOFC's.

Solid-oxide fuel cell (SOFC) commercial providers and/or manufacturers shall be interested in this technology to enhance the performance of their existing technology without alteration to their current product. The market outside of the U.S. may be larger, since Europe and Asia (especially Japan and Korea) have been investing heavily in the technology over the past two decades.

### Materials

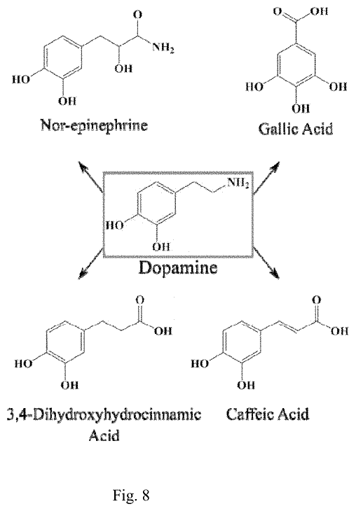

Any catechol compound that has a catechol benzene with hydroxyl side(s) may be used as the catechol based surfactant in the present invention. Some examples include, but are not limited to, Dopamine hydrochloride (3,4-Dihydroxyphenethylammonium chloride 3-Hydroxytyramine hydrochloride, (HO)₂C₆H₃CH₂CH₂NH₂HCl, Alfa Aesar), Epinephrine hydrochloride (DL-Adrenaline Hydrochloride, C₉H₁₃NO₃, Sigma Aldrich), DHC (3,4-Dihydroxyhydrocinnamic acid or 3-(3,4-Dihydroxyphenyl)propionic acid or Hydrocaffeic acid, (HO)₂C₆H₃CH₂CH₂CO₂H, Sigma Aldrich), Caffeic acid (3,4-Dihydroxybenzeneacrylic acid or 3,4-Dihydroxycinnamic acid or 3-(3,4-Dihydroxyphenyl)-2-propenoic acid, (HO)₂C₆H₃CH═CHCO₂H, TCI America), Gallic Acid (3,4,5-Trihydroxybenzoic acid, (HO)₃C₆H₂CO₂H, Alfa Aesar), Tiron (4,5-Dihydroxy-1,3-benzenedisulfonic acid disodium salt or Pyrocatechol-3,5-disulfonic acid disodium salt, C₆H₄Na₂O₈S₂, TCI America), Adrenalone hydrochloride (3 ‘,4’-Dihydroxy-2-(methylamino)acetophenone hydrochloride, C₉H₁₁NO₃ HCl, Sigma Aldrich), and nor-epinephrine. Molecular structures of the few of the catechol based surfactants mentioned here is shown in FIG. 8 representatively.

Reagent grade of nitric acid and ammonium hydroxide were used to shift the pH of catechol solution. To stabilize the pH of the catechol solution, TRIS buffer (Tris(hydroxymethyl)aminomethane, NH₂C(CH₂OH)₃ Alfa Aesar) can be used. As an oxidizing agent (i.e. oxidant), any halogen group oxidant agent can be used. However, the usage of strong halogen based oxidizers which have unstable and explosive character should be avoided. In that sense, oxidant agents such as for example, but not limited to, iodate (IO₃⁻), periodates (IO₄⁻), bromite (BrO₃⁻) and perbromate (BrO₄⁻) groups should be preferred. Some examples include, Tetrabutylammonium (meta) periodate ((CH₃CH₂CH₂CH₂)₄N(IO₄), Sigma Aldrich), Sodium periodate (Sodium (meta)periodate, NaIO₄, Sigma), Periodic acid (H₅IO₆, Sigma Aldrich), Perbromic acid (HBrO₄, Chemtik). Aforementioned chemicals can be supplied from different vendors and at various purities.

It will be appreciated by those persons skilled in the art that changes could be made to embodiments of the present invention described herein without departing from the broad inventive concept thereof. It is understood, therefore, that this invention is not limited by any particular embodiments disclosed, but is intended to cover the modifications that are within the spirit and scope of the invention, as defined by the appended claims.

What is claimed is:

1. A process for incorporating at least one nano-catalyst on the surface of and within a plurality of pores of an electrode comprising:
spraying a catechol based bio-surfactant onto a surface of and within one or more pores of a solid oxide electrochemical cell having an anode electrode and a cathode electrode;
spraying a nano-catalyst solution onto said surface of and within said one or more pores of said solid oxide electrochemical cell that has been pretreated with said catechol based bio-surfactant for forming a modified solid oxide electrochemical cell; and
firing said modified solid oxide electrochemical cell above a calcination temperature of said nano-catalyst solution for forming a nano-catalyst on said surface and within at least one or more pores of said solid oxide electrochemical cell.

2. The process of claim 1 wherein said catechol based bio-surfactant is one selected from the group consisting of dopamine hydrochloride (3,4-dihydroxyphenethylammonium chloride 3-hydroxytyramine hydrochloride, epinephrine hydrochloride, 3,4-dihydroxyhydrocinnamic acid, 3-(3,4-dihydroxyphenyl)propionic acid, hydrocaffeic acid, caffeic acid (3,4-dihydroxybenzeneacrylic acid), 3,4-dihydroxycinnamic acid, 3-(3,4-dihydroxyphenyl)-2-propenoic acid, gallic acid (3,4,5-Trihydroxybenzoic acid), 4,5-Dihydroxy-1,3-benzenedisulfonic acid disodium salt, pyrocatechol-3,5-disulfonic acid disodium salt, adrenalone hydrochloride (3′,4′-dihydroxy-2-(methylamino)acetophenone hydrochloride), and nor-epinephrine.

3. The process of claim 1, including after spraying said catechol based bio-surfactant onto said surface of and within one or more pores of said solid oxide electrochemical cell, and before spraying said nano-catalyst solution, spraying said catechol based bio-surfactant treated solid oxide electrochemical cell with an oxidant agent solution to cause polymerization of said catechol based bio-surfactant within a range of time from about one second to less than about one hour.

4. The process of claim 3, wherein said oxidant agent is one selected from the group consisting of an iodate (IO₃⁻) group, a periodate (IO₄⁻) group, a bromite (BrO₃⁻) group, and a perbromate (BrO₄⁻) group.

5. The process of claim 4 wherein said oxidant agent is one selected from the group consisting of tetrabutylammonium (meta) periodate ((CH₃CH₂CH₂CH₂)₄N(IO₄), sodium periodate (sodium (meta)periodate, NaIO₄, a periodic acid (H₅IO₆), and a perbromic acid (HBrO₄).

6. The process of claim 3 wherein said oxidant agent is an ammonium periodate solution.

7. The process of claim 1 including mixing said catechol based bio-surfactant with an oxidant agent solution to form a polymerizing mixture of said catechol based bio-surfactant and said oxidant solution, and then immediately spraying said polymerizing mixture onto said surface of and within one or more pores of said solid oxide electrochemical cell.

8. The process of claim 3, wherein said catechol based bio-surfactant is a nor-epinephrine solution and said oxidant agent is an ammonium periodate solution.

9. The process of claim 1 wherein said spraying of said catechol based bio-surfactant is in the form of an atomized aerosol.

10. A process for incorporating at least one nano-catalyst on the surface of and within a plurality of pores of an electrode comprising:
dripping by point deposition a catechol based bio-surfactant onto a surface of and within one or more pores of a solid oxide electrochemical cell having an anode electrode and a cathode electrode;
dripping by point deposition a nano-catalyst solution onto said surface of and within said one or more pores of said solid oxide electrochemical cell that has been pretreated with said catechol based bio-surfactant for forming a modified solid oxide electrochemical cell; and
firing said modified solid oxide electrochemical cell above a calcination temperature of said nano-catalyst solution for forming a nano-catalyst on said surface and within at least one or more pores of said solid oxide electrochemical cell.

11. The process of claim 10, including after dripping said catechol based bio-surfactant onto said surface of and within one or more pores of said solid oxide electrochemical cell, and before dripping said nano-catalyst solution, treating said catechol based bio-surfactant treated solid oxide electrochemical cell with an oxidant agent solution to cause polymerization of said catechol based bio-surfactant within a range of time from about one second to less than about one hour.

12. The process of claim 10, including mixing said catechol based bio-surfactant with an oxidant agent solution to form a polymerizing mixture of said catechol based bio-surfactant and said oxidant solution, and then immediately dripping by point deposition said polymerizing mixture onto a surface of and within one or more pores of said solid oxide electrochemical cell.
